(19) United States
(12) Patent Application Publication
(10) Pub. No.: US 2010/0208266 A1
(43) Pub. Date: Aug. 19, 2010

(54) TRISTIMULUS COLORIMETER HAVING INTEGRAL DYE FILTERS

(76) Inventors: COLMAN SHANNON, Lawrenceville, NJ (US); Michael Vrhel, Sammamish, WA (US)

Correspondence Address: WALL & TONG , LLP, 595 SHREWSBURY AVE., SHREWSBURY, NJ, 07702, US

(21) Appl. No.: 12/372,498

(22) Filed: Feb. 17, 2009

(51) Int. Cl. G01N 21/25

(52) U.S. Cl. 356/405

(57) ABSTRACT

One embodiment of a solid-state color-measuring device includes a plurality of photodetectors and a plurality of filters permanently deposited on the photodetectors, where at least one of the filters includes a single colorant layer having a transmission coefficient as a function of wavelength that descends from a maximum value between approximately 445 and 450 nm to fifteen percent of the maximum value between approximately 485 and 495 nm.

### BACKGROUND

1. Field of the Invention

The present invention generally relates to optics and colorimetry and, in particular, relates to tristimulus calorimeters having integral dye filters that measure the color content of light that has a response mimicking the response to color of the human eye, as may be represented by the Commission Internationale de I'Eclairage (CIE) color-matching functions.

2. Description of the Related Art

Optical filters are used in many color-related applications, including various color measurement systems, such as colorimeters. There are many types of filters, including absorptive filters, interference filters, and others. A photoelectric tristimulus colorimeter is used to measure the color of the light emitted from a light source, such as a computer display screen. This is an emissive color measurement, but there are also reflective color measurement devices. An emissive photoelectric colorimeter directs the light from the light source to be measured through an optical system toward three or more photoelectric detecting devices. A primary filter is positioned in front of each photoelectric detecting device. Each primary filter conforms, as closely as possible, the spectral sensitivity of the photoelectric detecting device to the respective color-matching functions. A measuring device, which is connected to the photoelectric detecting devices, reads or measures the amounts of the respective primaries or tristimulus values in response to the incident light.

Although it is theoretically possible to design primary filters exactly corresponding to an ideal, it is practically impossible to manufacture primary filters having transmission factors exactly corresponding to the ideal. Because of this lack of correspondence, there are differences between the actual and theoretical transmission factors of the primary filters, leading to errors in the tristimulus values of the light measured through these filters.

Past attempts to correct this error have involved attempts to alter the transmission factor characteristics of the primary filters by forming the primary filters using a number of superimposed colored plates. However, because the spectral characteristics of the colored plates depend upon the components of the materials used in the plates—normally glass—it was generally impossible to exactly match the theoretical transmission factors. It was prohibitively difficult to accurately duplicate the theoretical transmission values over the complete wavelength range of the measured light sources. These past attempts that increased the number of plates, undesirably decreased the amount of light received or passed through the primary filter. In addition, past attempts to fabricate primary filters by carefully superimposing a number of plates in an attempt to match theoretical transmission factors were time consuming and expensive.

### SUMMARY OF THE INVENTION

One embodiment of a solid-state color-measuring device includes a plurality of photodetectors and a plurality of filters permanently deposited on the photodetectors, where at least one of the filters includes a single colorant layer whose transmission coefficient as a function of wavelength descends from a maximum value between approximately 445 and 450 nm, to fifteen percent of the maximum value between approximately 485 and 495 nm (denoted herein as “purple” for reference convenience).

### BRIEF DESCRIPTION OF THE DRAWINGS

The teachings of the present invention can be readily understood by considering the following detailed description in conjunction with the accompanying drawings, in which:

FIG. 1 is a top view of an exemplary embodiment of a configuration of dye filter layers on a semiconductor chip having photodetectors;

FIG. 2A is a top view of an exemplary embodiment of another configuration of dye filter layers on a semiconductor chip having photodetectors;

FIG. 2B is a side view of FIG. 2A;

FIG. 3A is a top view of an exemplary embodiment of yet another configuration of dye filter layers on a semiconductor chip constructed with five photodetectors and four dye filter layers, including one unfiltered photodetector;

FIG. 3B is a side view of FIG. 3A;

FIG. 4 is a graph of exemplary filter transmission values for the exemplary embodiment of FIGS. 1, 2A, and 2B;

FIG. 5 is a graph of exemplary ultraviolet (UV) and infrared (IR) filter transmission values and the normalized silicon photodetector response for the exemplary embodiment of FIGS. 1, 2A, 2B, 3A, and 3B;

FIG. 6 is a graph of an exemplary normalized filter detector response for the exemplary embodiment of FIGS. 1, 2A, and 2B;

FIG. 7 is a graph comparing a best fit of the response functions of the exemplary embodiment of FIGS. 1, 2A, and 2B to target CIE 1931 two-degree color-matching functions;

FIG. 8A is a list of an exemplary set of equations to calculate tristimulus values using the exemplary embodiment of FIGS. 1, 2A, and 2B;

FIG. 8B is a table of exemplary coefficients computed using the equations of FIG. 8A for the best fit of FIG. 7;

FIG. 9A is a block diagram of an exemplary embodiment of a computer monitor calibration system;

FIG. 9B is a block diagram of another exemplary embodiment of the computer monitor calibration system of FIG. 9A, in which the colorimeter chip and its controlling microprocessor are embedded within the computer monitor under test;

FIG. 10A is a block diagram of an exemplary embodiment of a home theatre display calibration system;

FIG. 10B is a block diagram of another exemplary embodiment of the home theatre display calibration system of FIG. 10A, in which the calorimeter chip and its controlling microprocessor are embedded within the home theatre display under test;

FIG. 11A is a block diagram of an exemplary embodiment of a projector calibration system, in which the colorimeter chip views the light emitted from the projector directly;

FIG. 11B is a block diagram of another exemplary embodiment of the projector calibration system of FIG. 11A, in which the calorimeter chip views the light emitted from the projector after reflection from a display screen;

FIG. 12 is a block diagram of an exemplary embodiment of an ambient light measurement system;

FIG. 13 is a block diagram of an exemplary embodiment of a light emitting diode (LED) measurement and control application;

FIG. 14 is a graph of exemplary spectral response values from a standard four-channel color sensor with red, green, blue, and clear filtered detector responses;

FIG. 15 is a graph of the least-square best fits to the CIE x̅, y̅, and z̅ functions of linear combinations of the four spectral response functions illustrated in FIG. 14;

FIG. 16 is a graph showing the relative transmission functions for various thicknesses of the custom purple filter on glass, plotted from 400 to 700 nm; and

FIG. 17 is a graph showing the part of the purple curve that, in one embodiment, has the greatest significance in terms of characterization.

To facilitate understanding, identical reference numerals have been used, where possible, to designate identical elements that are common to the figures.

### DETAILED DESCRIPTION

The present invention includes various embodiments of a calorimeter having integral dye filters embedded onto a semiconductor chip. Dye filters include colorants, pigments, dyes, and the like. Some embodiments described include a computer monitor calibration system, a home theatre display calibration system, a projector calibration system, an ambient light measurement system, a light emitting diode (LED) measurement and control application, and combinations thereof, each including a calorimeter having integral dye filters embedded onto a semiconductor chip. For a computer monitor and related applications, the sensor can be either free-standing or embedded in the monitor being calibrated. However, embodiments of the present invention have many applications in colorimetry in addition to these.

Colorimetry is the science and practice of determining and specifying colors and quantitative analysis by color comparison. In colorimetry, colors can be described in numbers, and physical color can be matched using a variety of measurement instruments, such as calorimeters, spectrophotometers, densitometers, and spectroradiometers. Colorimetry is used in many industries, including photography, soft-proofing, digital color communication, interior design, architecture, consumer electronics, chemistry, color printing, textile manufacturing, and paint manufacturing, among others. A person of ordinary skill in the art will recognize that the present invention is applicable to many applications of colorimetry in many industries and to many kinds of measurement instruments.

One embodiment of the present invention is a color-measuring device, such as a calorimeter. The calorimeter is a solid-state device having light detectors and filters. Colorants are permanently deposited onto the solid-state device using methods familiar to those of ordinary skill in the art of manufacturing solid-state light detectors. The device has an output of spectral responses that are linearly combined to approximate CIE or CIE-like color-matching functions. Some examples of CIE-like color matching functions include the CIE 1931 two-degree color-matching functions, CIE 1964 ten-degree color-matching functions, or modifications of the CIE functions, such as derived by D. Judd (1951) or by J. J Vos (1978). In one embodiment, the colorants are in the form of dyes or pigments. The colorants are permanently deposited onto either a single detector or a plurality of detectors on the device.

One embodiment of the present invention is a method of designing a color-measuring device such as that described above. A solution of combinations of colorants is derived, where the solution determines the type and layer thicknesses of the colorant to be used to filter a given light detector. In one embodiment, this method is computational and may operate on a processor. In one embodiment, the method results in a selection of the optimum layer thicknesses of the colorant according to predetermined criteria. The colorants are used on the light detectors, which have known responses to light photons. The colorants are computationally selected from a larger set of colorants. The computation takes into account the combined response of the colorants and the detectors to select the best or optimum solution so that the output of the device has spectral responses that are close to or approximate CIE or CIE-like color-matching functions and so that the performance of the device meets predetermined criteria.

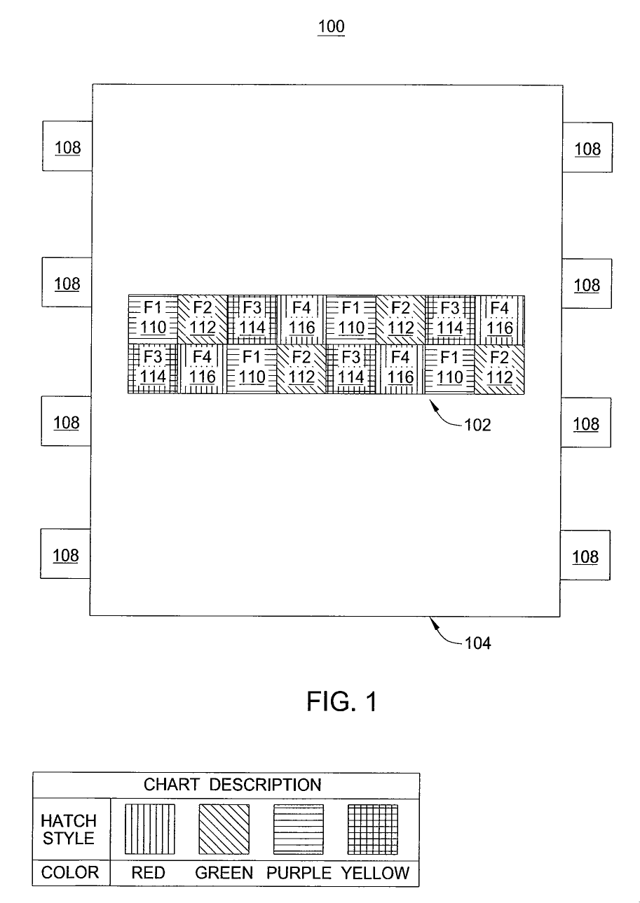

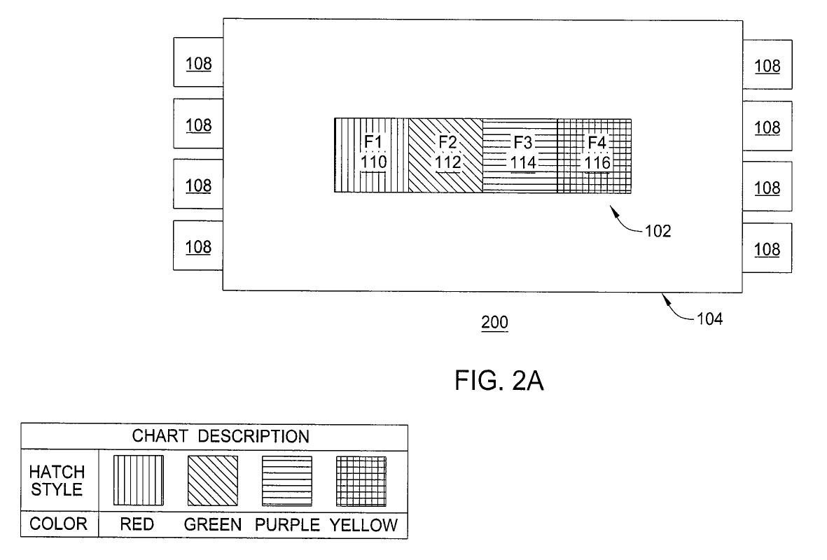

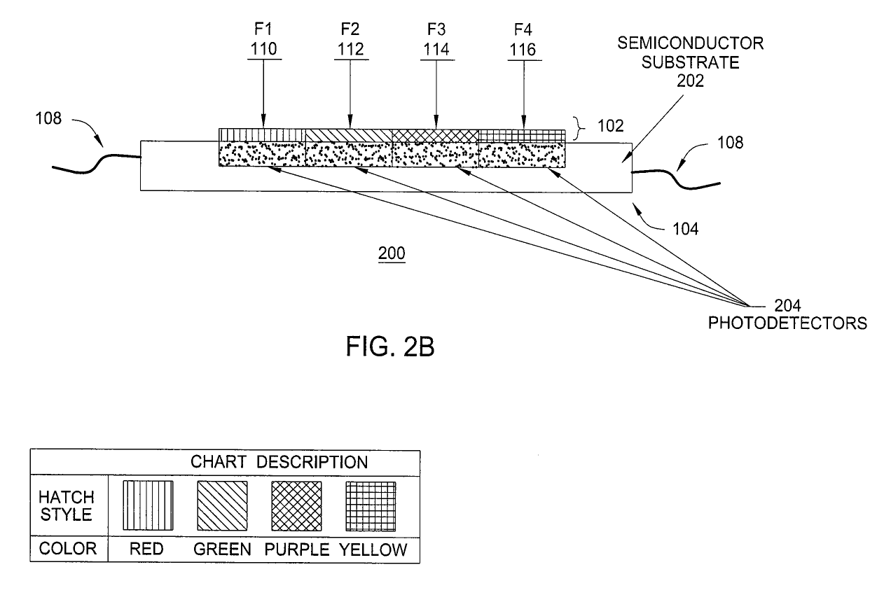

FIG. 1 is a top view of an exemplary embodiment of a configuration 100 of dye filter layers 102 on a semiconductor chip (e.g., a light-to-digital semiconductor device) having photodetectors (components 204 in FIG. 2B). Photodetectors are also known as photodiodes, photosensor elements, and photodetecting elements. The semiconductor chip 104 illustrated in FIG. 1 has a standard eight-pin 108 integrated circuit package; however, other package types can be used. There are many possible configurations 100 of dye filters 102, and FIG. 1 illustrates one possible configuration 100. In FIG. 1, there are sixteen dye filter layers 102 that are integral with sixteen photodetectors in a 2×8 grid pattern. Each photodetector is covered by one of four types of absorptive colorant filters (e.g., purple F1 filters 110, green F2 filters 112, yellow F3 filters 114, and red F4 filters 116). In FIG. 1, four photodetectors are covered by purple F1 filters 110, four photodetectors are covered by green F2 filters 112, four photodetectors are covered by yellow F3 filters 114, and four photodetectors are covered by red F4 filters 116. The purple F1 filters 110, green F2 filters 112, yellow F3 filters 114, and red F4 filters 116 are each single layer filters. Other embodiments include more or fewer types of filters.

FIG. 2A is a top view of an exemplary embodiment of another configuration 200 of dye filter layers 102 on a semiconductor chip 104 having photodetectors (components 204 in FIG. 2B). The semiconductor chip 104 has a standard eight-pin 108 integrated circuit package; however, other package types can be used. Other embodiments have a different number of pins 108. In FIG. 2A, each photodetector is covered by one of four types of integral absorptive colorant layers 102 (i.e., red F1 filters 110, green F2 filters 112, purple F3 filters 114, and yellow F4 filters 116), each of which is a single-layer structure. Colorants include pigments, dyes, and the like.

FIG. 2B is a side view of FIG. 2A, showing a cross section of the dye filter layers 102. In this exemplary embodiment, the semiconductor chip 104 includes a semiconductor substrate 202 constructed (e.g., by depositing) with four photodetectors 204 and four dye filter layers 102. Each dye filter layer 102 is integral with one of the photodetectors 204. In FIG. 2B, F1 filter 110, F2 filter 112, F3 filter 114, and F4 filter 116 all comprise single-layer structures. Specifically, F1 filter 110 comprises a single red layer, F2 filter 112 comprises a single green layer, F3 filter 114 comprises a single purple layer, and F4 filter 116 comprises a single yellow layer. In other embodiments, there are at least three photodetectors 204 with corresponding dye filters 102.

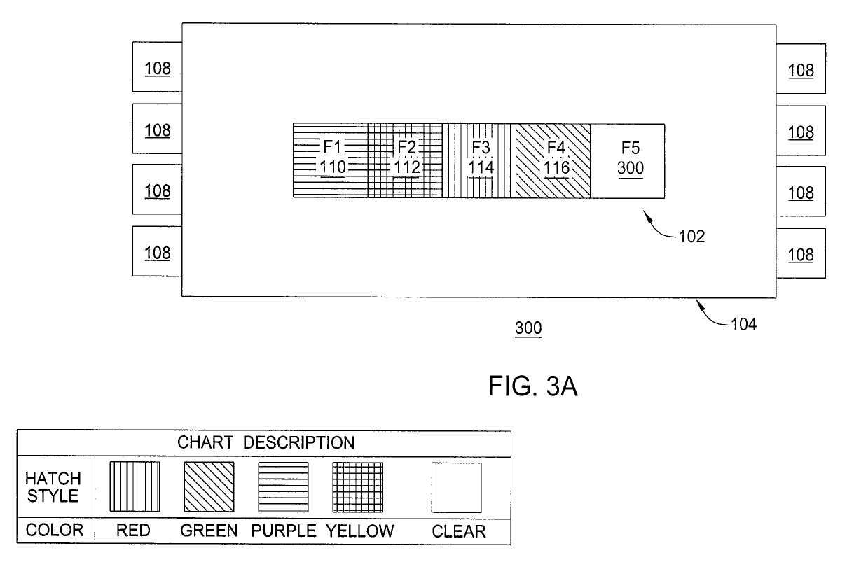

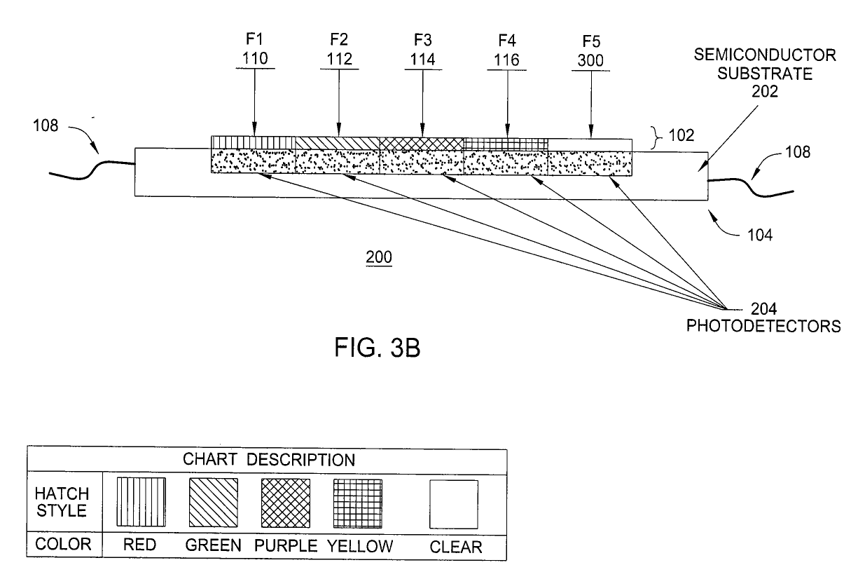

FIG. 3A is a top view of an exemplary embodiment of yet another configuration 300 of dye filter layers 102 on a semiconductor chip 104 constructed with five photodetectors 204 and four dye filter layers 102, including one unfiltered photodetector. Each dye filter layer 102 is integral with one of the photodetectors 204. One of the photodetectors 300 is to be covered with a clear coating that does not contain any colorants.

FIG. 3B is a side view of FIG. 3A. In this exemplary embodiment, the semiconductor chip 104 includes a semiconductor substrate 202 constructed with five photodetectors 204 and four dye filter layers 102. Each dye filter layer 102 covers one of the photodetectors 204. In FIG. 3B, F1 filter 110, F2 filter, 112, F3 filter 114, and F4 filter 116 are all colored filters, while F5 filter 300 is clear (no colorants).

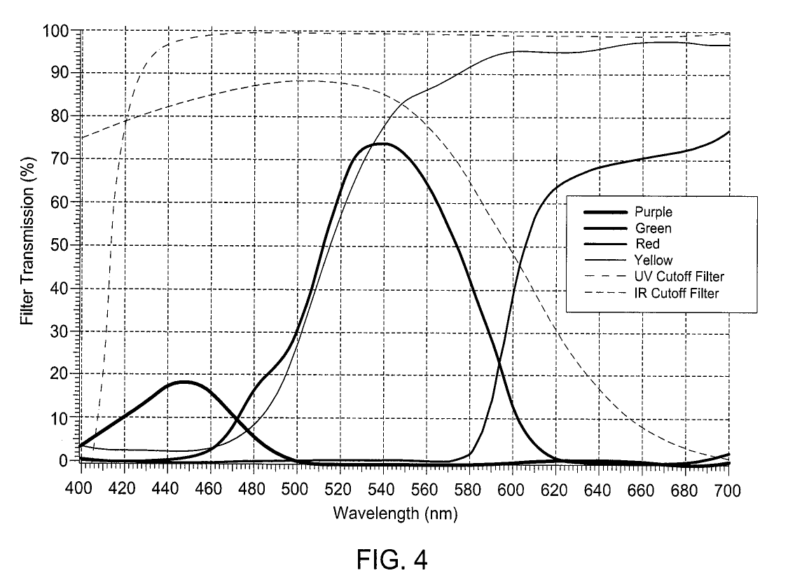

FIGS. 4-8 illustrate the process of computing the measured X, Y, and Z tristimulus values using the exemplary embodiment of FIGS. 2A and 2B.

FIG. 4 is a graph of exemplary filter transmission values for the exemplary embodiment of FIGS. 1, 2A, and 2B. FIG. 4 shows the transmission of four filter functions, F1, F2, F3, and F4. The photosensitive colors PSC® red and green colorants listed in FIG. 4 are part of a family of pigments that are commonly used for producing color filter layers on semiconductor devices. Similarly, the Dyed (PSD™) yellow colorant is part of another family of dyes that are commonly used for producing color filter layers on semiconductor devices. The purple colorant is not a commonly used dye for producing color filter layers on semiconductor devices, and has been formulated specifically to have a transmission coefficient as a function of wavelength that descends from a maximum value between approximately 445 and 450 nm, to fifteen percent of the maximum value between approximately 485 and 495 nm. Other embodiments may include any other pigments, dyes, and colorants suitable for construction of a semiconductor device. Other embodiments may also comprise the purple filter out of multiple layers of filters on top of each other.

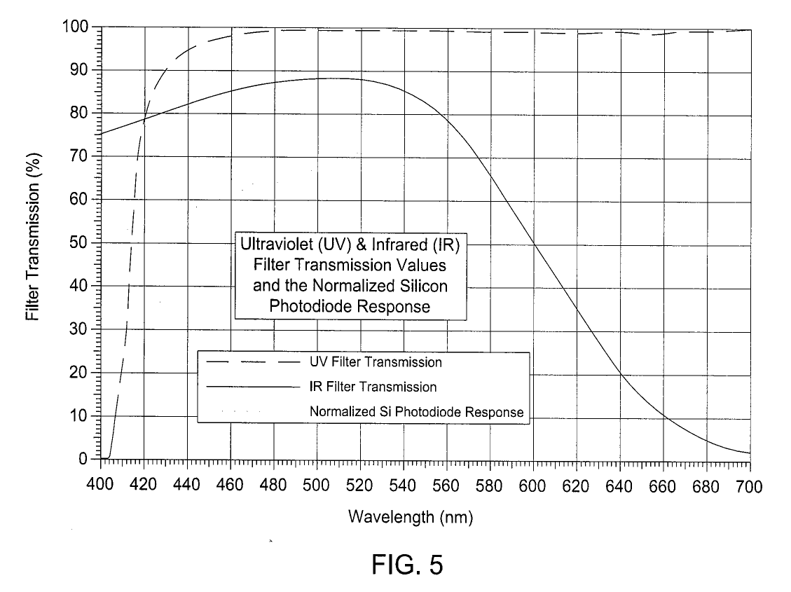

FIG. 5 is a graph of exemplary ultraviolet (UV) and infrared (IR) filter transmission values for the exemplary embodiment of FIGS. 1, 2A, 2B, 3A, and 3B. Also plotted in FIG. 5 is a typical silicon photodiode spectral response function. FIG. 5 shows the transmission of the UV and IR filters that are needed to narrow the spectral range of the light that reaches the calorimeter chip.

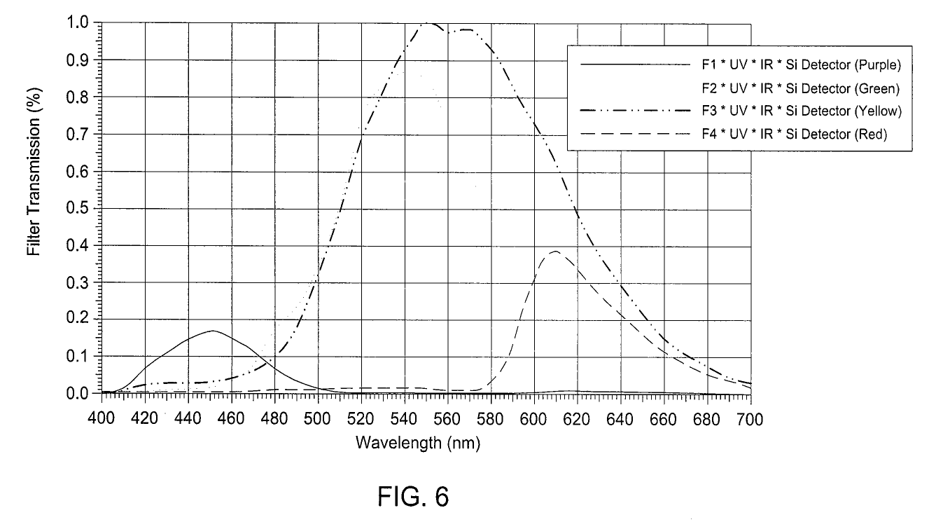

FIG. 6 is a graph of an exemplary normalized filter detector response for the exemplary embodiment of FIGS. 1, 2A, and 2B. The illustrated response functions are obtained by multiplying the filter transmissions shown in FIG. 4 by the UV and IR and silicon photodetector functions shown in FIG. 5.

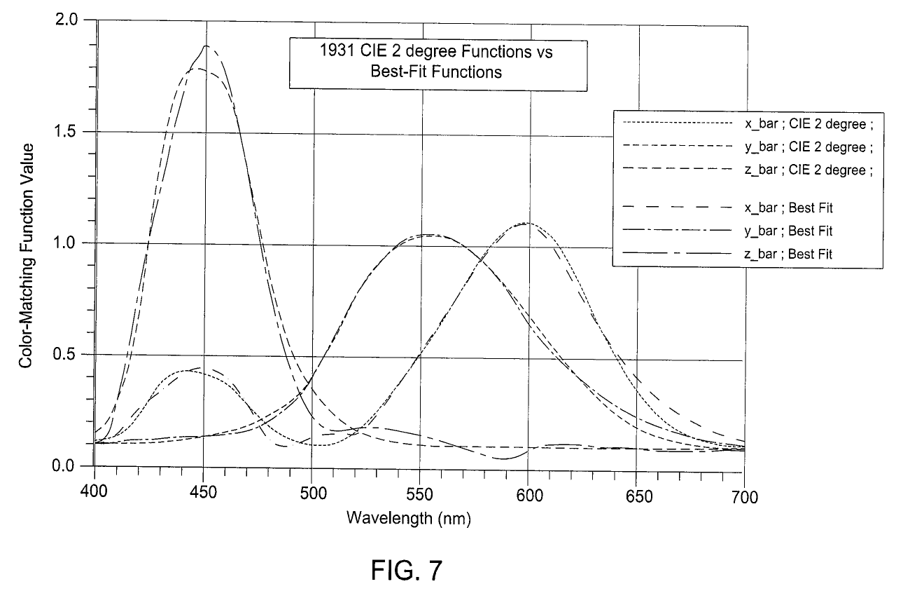

FIG. 7 is a graph comparing a best fit of the response functions of the exemplary embodiment of FIGS. 1, 2A, and 2B to the 1931 two-degree CIE color-matching functions. This fit was obtained by performing a least squares fit to the CIE functions using the response functions shown in FIG. 6.

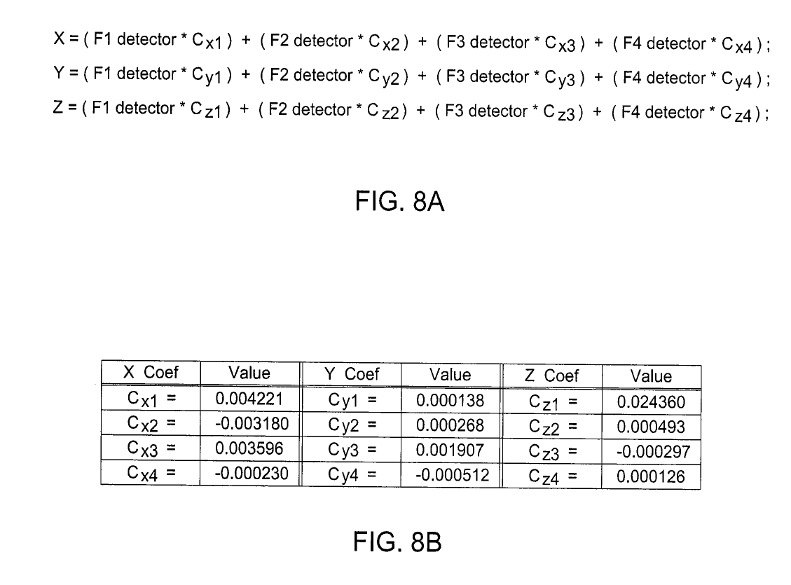

FIG. 8A is a list of an exemplary set of equations to calculate tristimulus values using the exemplary embodiment of FIGS. 1, 2A, and 2B. The set of equations is as follows and uses the best fit least squares coefficients for calculating the X, Y, and Z tristimulus values.

X=(F1detector*Cₓ₁)+(F2detector*Cₓ₂)+(F3detector*Cₓ₃)+(F4detector*Cₓ₄);

Y=(F1detector*C_{Y1})+(F2detector*C_{Y2})+(F3detector*C_{Y3})+(F4detector*C_{Y4});

Z=(F1detector*Cₓ₁)+(F2detector*C_{Z2})+(F3detector*C_{Z3})+(F4detector*C_{Z4});

FIG. 8B is a table of exemplary coefficients computed using the equations of FIG. 8A for the best fit of FIG. 7. The table is as follows and shows exemplary values of the best fit coefficients Cⱼₖ.

| X Coef | Value | Y Coef | Value | Z Coef | Value |
|---|---|---|---|---|---|
| Cₓ₁ = | 0.004221 | C_{y1} = | 0.000138 | C_{z1} = | 0.024360 |
| Cₓ₂ = | −0.003180 | C_{y2} = | 0.000268 | C_{z2} = | 0.000493 |
| Cₓ₃ = | 0.003596 | C_{y3} = | 0.001907 | C_{z3} = | −0.000297 |
| Cₓ₄ = | −0.000230 | C_{y4} = | −0.000512 | C_{z4} = | 0.000126 |

Various exemplary embodiments may be generated using a method for designing a colorimeter having integral CIE color-matching filters. This method can be used to calculate filter layer structure and thicknesses of layers. A set of channels is determined from a plurality of channels so that a linear combination of the set of channels matches a set of CIE-like target color-matching functions within a tolerance. Each channel integrates one detector and one filter on a single semiconductor substrate. Each filter is an absorptive filter and consists of a single colorant layer. A thickness is determined for each colorant layer. A colorant is determined for each channel from a set of colorants. With a sufficiently high signal-to-noise ratio (SNR), good accuracy is obtainable for a colorimeter with at least three or four channels, where each filter comprises a single colorant layer. This maximizes the approximation to the CIE-like target color-matching functions while minimizing the cost. Other exemplary embodiments of colorimeters exhibiting good performance and accuracy include a five-channel system in which four channels have color filters and the fifth channel has a clear filter layer. Some exemplary embodiments have filter layer thicknesses between approximately 0.50 and 3.00 microns. One of ordinary skill in the art will recognize that various other combinations of layer structures and thicknesses are also within the scope of the present invention.

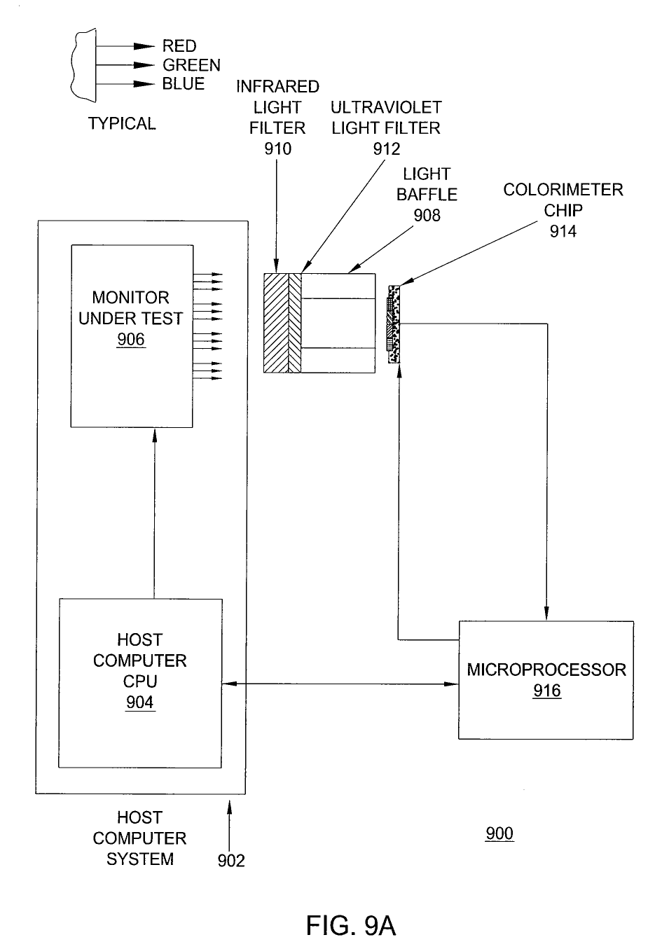

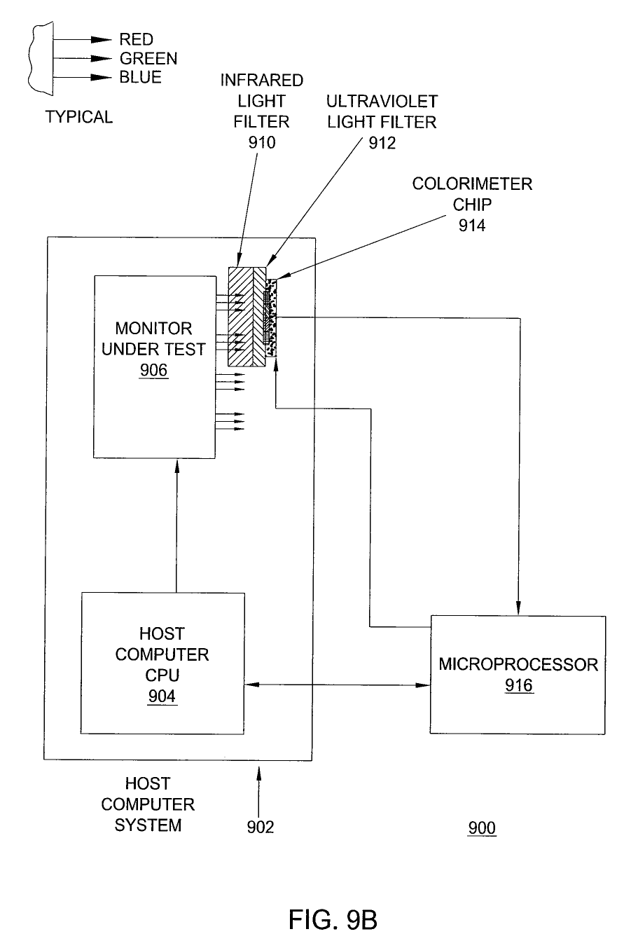

FIG. 9A is a block diagram of an exemplary embodiment of a computer monitor calibration system 900. In this exemplary embodiment, the computer monitor calibration system 900 includes a host computer system 902. The host computer system 902 includes a computer processing unit (CPU) 904 and a monitor under test 906. The CPU 904 runs a monitor calibration application and controls the red, green, and blue output to the monitor under test 906. The monitor under test 906 emits red, green, and blue light that travels through, an infrared light filter 910, an ultraviolet light filter 912, and a light baffle 908, and then travels toward a calorimeter chip 914 with integral dye filters. The light baffle 908 restricts the angle of the light detected, and the infrared light filter 910 and ultraviolet light filter 912 restrict the spectral range of the light detected by the colorimeter chip 914. However, other embodiments may include none of these or one or more of these filters or other filters in different orders or arrangements, as needed.

The colorimeter chip 914 sends an input of raw count data to a microprocessor 916, and the microprocessor 916 sends control commands to the colorimeter chip 914. The microprocessor 916 thus controls the operation of the colorimeter chip 914. There is two-way communication (e.g., via cable, USB, or wireless means) between the microprocessor 916 and the CPU 904. Although shown outside in FIG. 9A for illustrative purposes, the microprocessor 916 is located inside calibrator device housing. The microprocessor 916 sends command input and raw data output. The present invention is not limited to any particular arrangement of parts of the computer monitor calibration system. Nor is the present invention limited to computer monitor calibration systems; the present invention includes various other colorimetry applications. Other embodiments include various alternative arrangements of the major components of the computer monitor system; for example, the CPU 904 and monitor 906 may be combined.

FIG. 9B is a block diagram of another exemplary embodiment of the computer monitor calibration system 900 of FIG. 9A, in which the calorimeter chip and its controlling microprocessor are embedded within the computer monitor under test. FIG. 9B differs from the computer monitor calibration system 900 of FIG. 9A in that the colorimeter chip 914 and its microprocessor controller 916 are embedded in the monitor under test 906. In other words, the calorimeter chip 914 is attached directly to the screen of the monitor under test 906, inside the housing of the monitor under test 906.

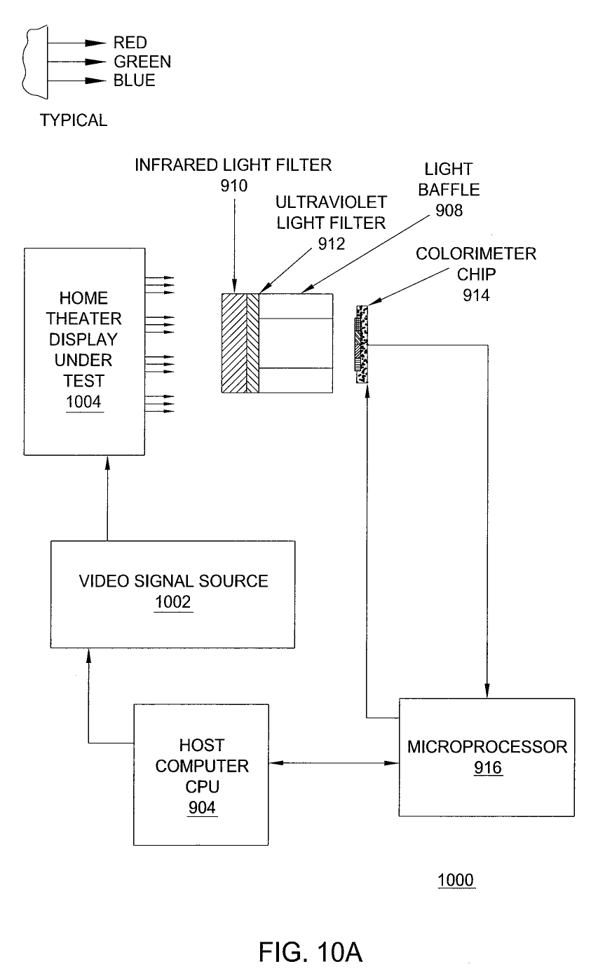

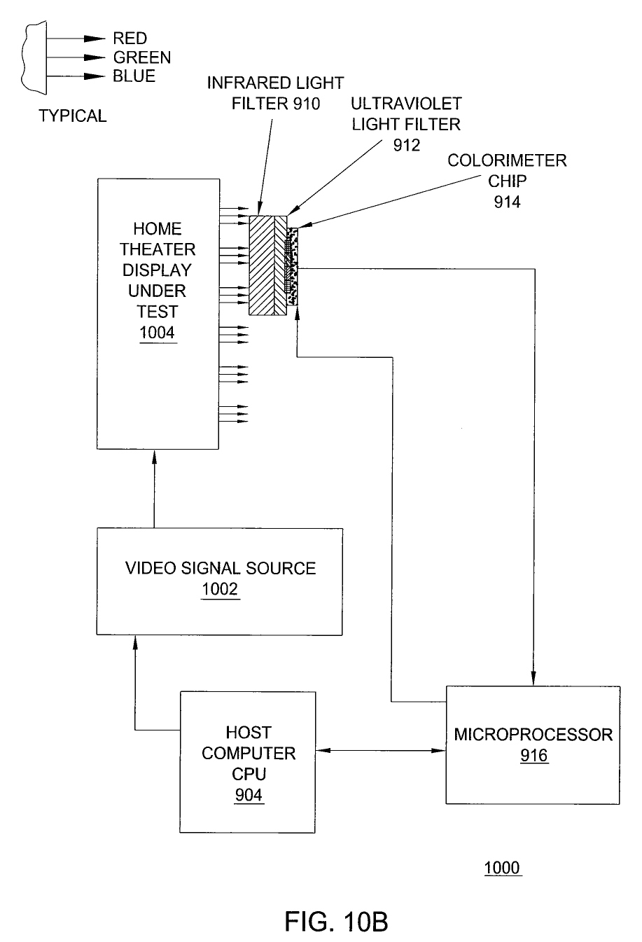

FIG. 10A is a block diagram of an exemplary embodiment of a home theater display calibration system 1000. In one embodiment, a home theater display includes a plasma television (TV), a Liquid Crystal Display (LCD) TV, a Digital Light Processing™ (DLP®) TV, or the like. In this exemplary embodiment, the host computer CPU 904 is running a home theater calibration application. The video signal source 1002 for the home theater is a video source, such as a digital video disk (DVD) player or a video signal generator. The host computer CPU 904 sends command output to control the video signal source 1002. The host computer CPU 904 has two-way communication with the microprocessor 916. The microprocessor 916 is located in the calibrator device housing. The microprocessor 916 controls the calorimeter chip 914. The calorimeter 914 has integral dye filters and sends raw count data to the microprocessor 916. The video signal source 1002 sends video signal output to a home theater display under test 1004. The home theater display under test 1004 emits light toward the infrared light filter 910. The light passes through the infrared filter 910 to the ultraviolet light filter 912, the light baffle 908 and, then, to the colorimeter chip 914. One of ordinary skill in the art will recognize that other embodiments may have more or less components in different arrangements for other colorimetry applications, yet these other embodiments are still within the inventive concept.

FIG. 10B is a block diagram of another exemplary embodiment of the home theatre display calibration system 1000 of FIG. 10A, in which the colorimeter chip and its controlling microprocessor are embedded within the home theatre display under test. In this exemplary embodiment, the colorimeter chip 914 with integral dye filters, along with the infrared light filter 910, ultraviolet light filter 912, and other associated components, including the microprocessor controller 916, are all located inside the housing of the home theater display under test 1004 (which is being calibrated). In other words, the calorimeter chip 914 is attached directly to the display screen of the home theater display under test 1004. Likewise, other arrangements of different and varied components are also within the scope of the present invention.

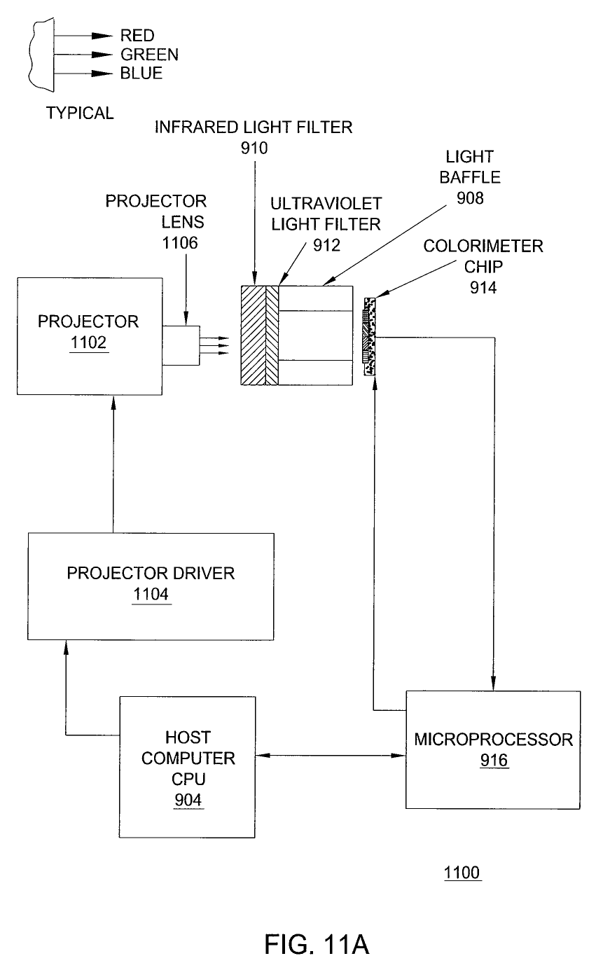

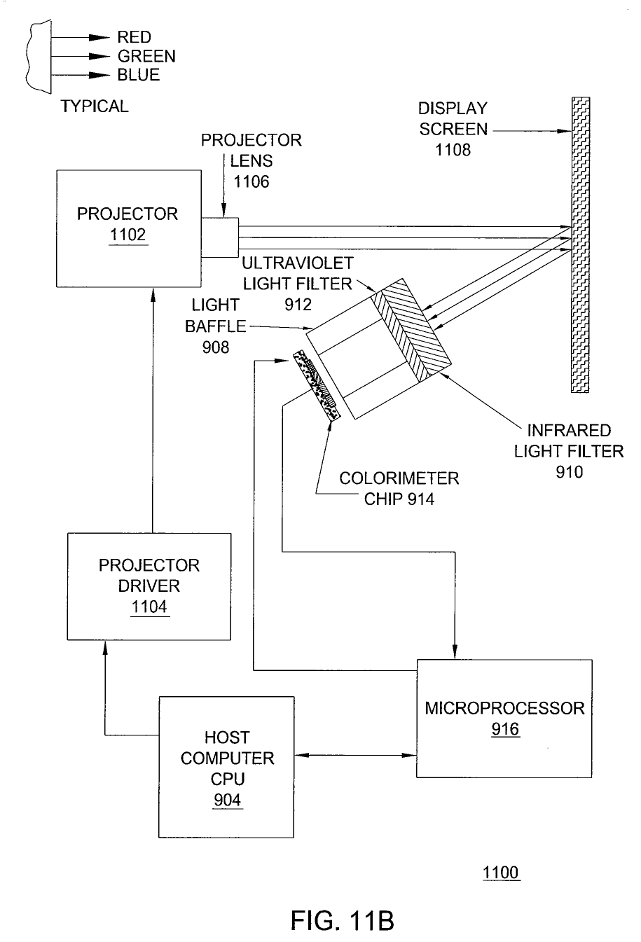

FIG. 11A is a block diagram of an exemplary embodiment of a projector calibration system 1100, in which the colorimeter chip views the light emitted from the projector directly. In this exemplary embodiment, the colorimeter chip 914 directly views the light emitted from a projector 1102. The signal source is a projector driver 1104, such as a computer video card or a video source (e.g., a DVD player or a video signal generator). The host computer CPU 904 sends command output to control the projector driver 1104, and the projector driver 1104 sends a signal output toward the projector 1102. Light is emitted through a projector lens 1106 toward the infrared light filter 910, ultraviolet light filter 912, the light baffle 908, and the calorimeter chip 914. The host computer CPU 904 has two-way communication with the microprocessor 916. The microprocessor receives raw count data from the colorimeter chip 914 and sends control commands to the calorimeter chip 914.

FIG. 11B is a block diagram of another exemplary embodiment of the projector calibration system 1100 of FIG. 11A, in which the calorimeter chip views the light emitted from the projector after reflection from a display screen. In this exemplary embodiment, the colorimeter chip 914 views the light reflected from a display screen 1108, after the light is emitted from the projector 1102 through the projector lens 1106. Likewise, other arrangements of different and varied components are also within the scope of the present invention.

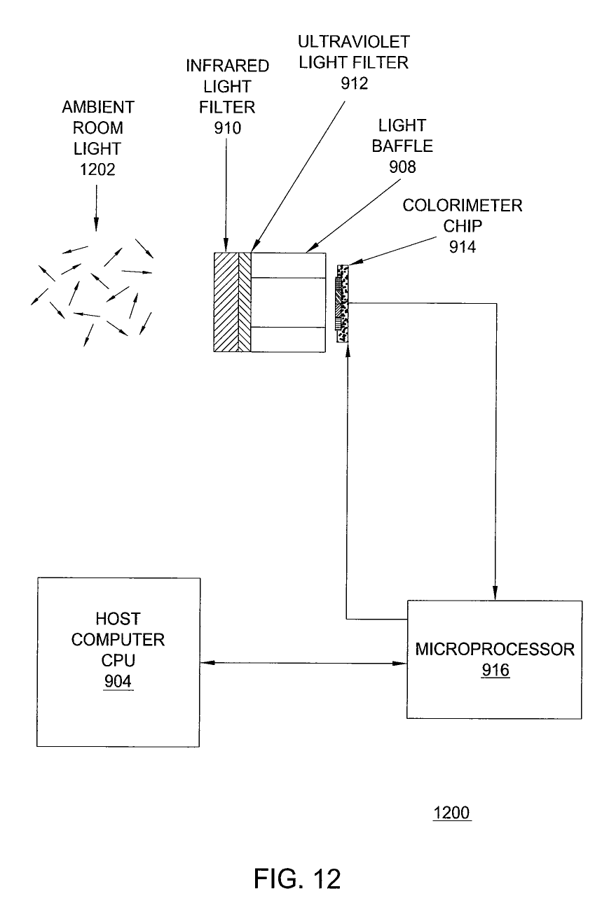

FIG. 12 is a block diagram of an exemplary embodiment of an ambient light measurement system 1200. In this exemplary embodiment, there is no specific light emitting source being calibrated. Instead, the ambient room light 1202 is being characterized in terms of, for example, luminance level and colorimetric readings. One of skill in the art will recognize that various arrangements of different and varied components of ambient light measurement systems 1200 are also within the scope of the present invention.

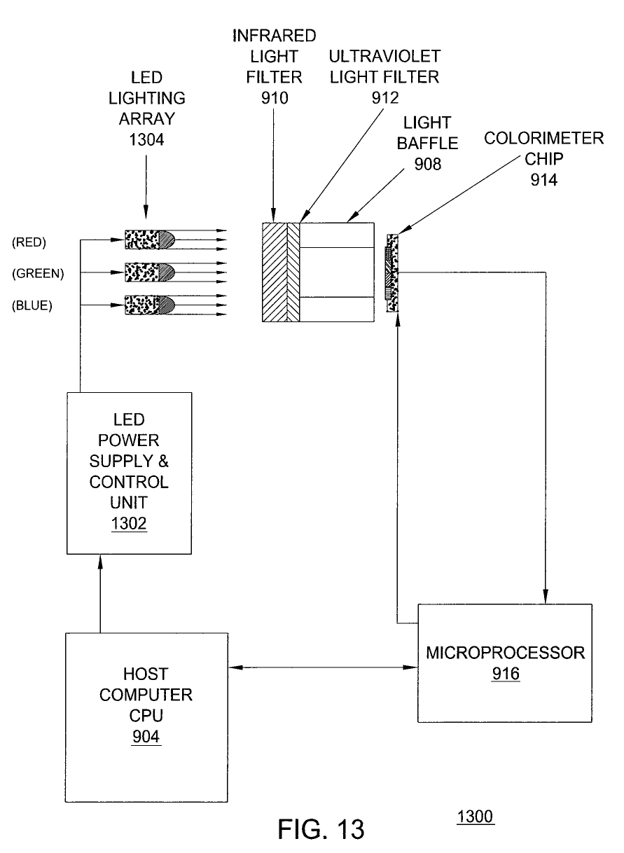

FIG. 13 is a block diagram of an exemplary embodiment of a light emitting diode (LED) measurement and control application 1300. In this exemplary embodiment, the host computer CPU 904 sends command input to an LED power supply and control unit 1302, which provides power supply outputs to LEDs in an LED lighting array 1304. Light emitted from the LEDs is directed toward the infrared light filter 910, ultraviolet light filter 912, light baffle 908, and colorimeter chip 914. One of skill in the art will recognize that various arrangements of different and varied components of LED measurement and control applications 1300 are also within the scope of the present invention.

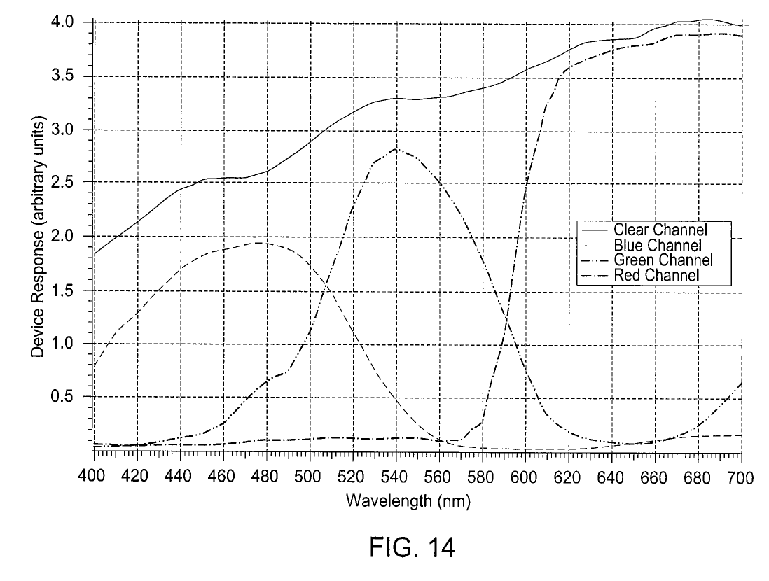

FIG. 14 is a graph of exemplary spectral response values from a standard four-channel color sensor with red, green, blue, and clear filtered detector responses. The color sensor is a TCS230 sensor manufactured by TAOS Inc. of Plano, Tex. The spectral responses are measured as a function of wavelength (in nm). No UV or IR filters are used.

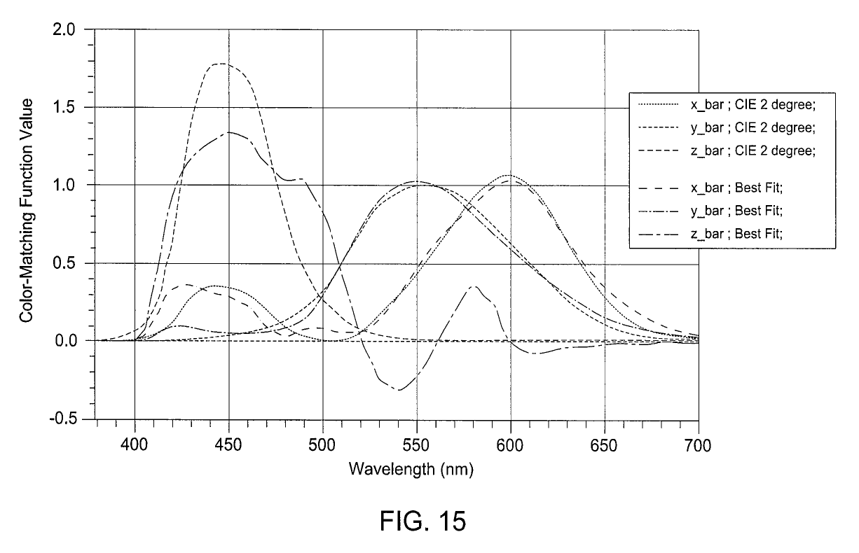

FIG. 15 is a graph of the least-square best fits to the CIE x̅, y̅, and z̅ functions of linear combinations of the four spectral response functions illustrated in FIG. 14. The least-square best fits are modulated by the UV and IR filters shown in FIG. 5. As illustrated, the fit to the z̅ function (blue sensitivity) is relatively poor.

Thus, it is apparent from FIGS. 14 and 15 that, although linear combinations of standard filter-fronted sensors to color-matching functions can be made, the fits may not be very good. To mitigate this, the filter spectral properties must be carefully controlled. In other words, “off-the-shelf” solutions will not provide the desired results.

Referring back to FIG. 7 (which is the analogue of FIG. 15 but employs different filters), the results when the filters are carefully chosen are illustrated. In the case of FIG. 7, the red, green, and yellow filters are standard off-the-shelf filters whose thicknesses are custom-controlled. However, the purple filter is a custom filter, specified as a target transmission curve.

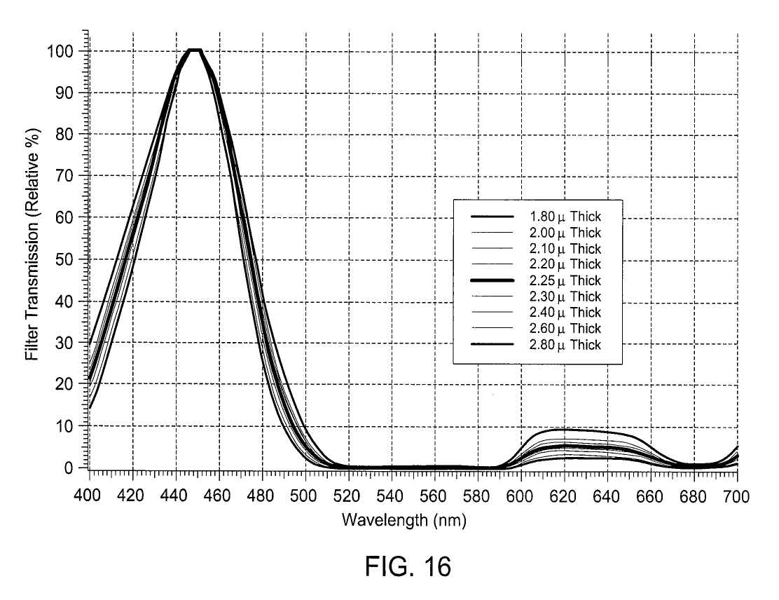

FIG. 16 is a graph showing the relative transmission functions for various thicknesses of the custom purple filter on glass, plotted from 400 to 700 nm. The target curve in this case is the one whose labeled thickness is 2.25 microns. Because the red contribution is relatively small for this filter (i.e., between approximately 600 and 660 nm), it should be noted that the description “purple” is used only for convenience.

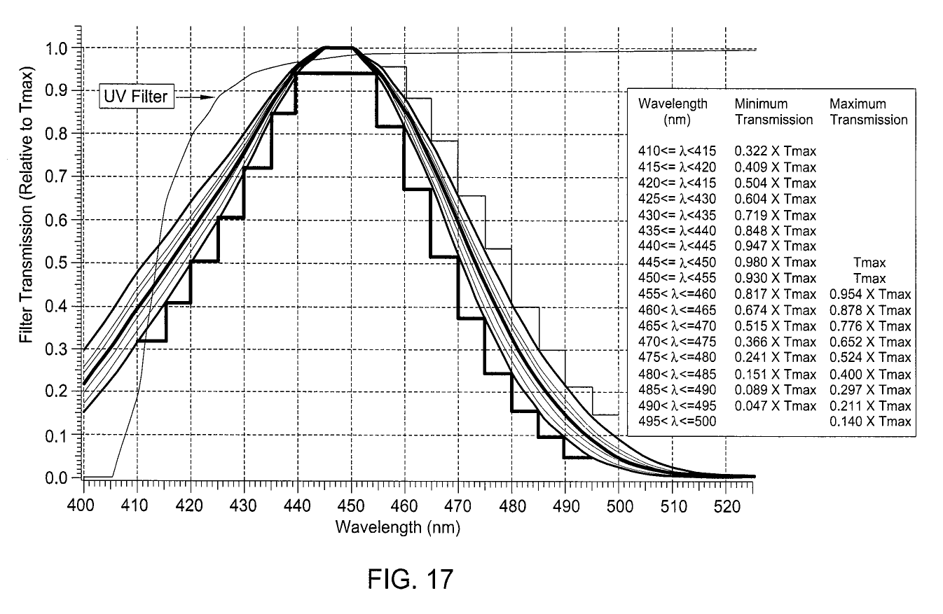

FIG. 17 is a graph showing the part of the purple curve that, in one embodiment, has the greatest significance in terms of characterization. In this embodiment, the relative transmittance (which peaks at 1.0) must be a curve that lies no lower than the inner staircase bound (e.g., between approximately 410 and 495 nm in FIG. 19), but no higher than the outer staircase bound (e.g., between approximately 460 and 500 nm in FIG. 17). Empirical studies have demonstrated that, for CIE function fit, the most significant part of the purple filter curve is the transition from high to low transmittance (i.e., between approximately 450 and 500 nm in FIG. 17). This is where the upper and lower bounds are defined; however, the upper bound at 450 nm is not explicitly illustrated because no transmittance can exceed 1.0 relative transmittance. An upper bound between 400 and 450 nm does not need to be defined, as it will naturally occur with a UV-blocking filter. The UV-blocking filter should have a transmission coefficient that varies from a minimum of close to zero at wavelengths of approximately 400 nm and below, to a maximum transmission at wavelengths in the range of approximately 410 to 450 nm.

Referring back to FIG. 4, the purple curve is illustrated in absolute transmittance units (i.e., not peaking at 1.0). It is apparent from FIG. 4 that the transmittance is fairly low relative to the transmittances of the green, yellow, and red filters. For completeness, the transmittance curves of the UV and IR filters are shown on the same graph.

In summary, FIG. 17 illustrates that the transmission coefficient (T) of the purple filter as a function of wavelength satisfies a set of conditions relative to a maximum transmission (Tₘₐₓ) of T. In one embodiment, the set of conditions is as follows: for wavelengths between approximately 410 and 415 nm, T is at least approximately 32.2 percent of Tₘₐₓ; for wavelengths between approximately 415 and 420 nm, T is at least approximately 40.0 percent of Tₘₐₓ; for wavelengths between approximately 420 and 425 nm, T is at least approximately 50.42 percent of Tₘₐₓ; for wavelengths between approximately 425 and 430 nm, T is at least approximately 60.4 percent of Tₘₐₓ; for wavelengths between approximately 430 and 435 nm, T is at least approximately 71.9 percent of Tₘₐₓ; for wavelengths between approximately 435 and 440 nm, T is at least approximately 84.8 percent of Tₘₐₓ; for wavelengths between approximately 440 and 445 nm, T is at least approximately 94.7 percent of Tₘₐₓ; for wavelengths between approximately 445 and 450 nm, T is at least approximately 98.0 percent of Tₘₐₓ and at most approximately Tₘₐₓ; for wavelengths between approximately 450 and 455 nm, T is at least approximately 93.0 percent of Tₘₐₓ and at most approximately Tₘₐₓ; for wavelengths between approximately 455 and 460 nm, T is at least approximately 81.7 percent of Tₘₐₓ and at most approximately 95.4 percent of Tₘₐₓ; for wavelengths between approximately 460 and 465 nm, T is at least approximately 67.4 percent of Tₘₐₓ and at most approximately 87.8 percent of Tₘₐₓ; for wavelengths between approximately 465 and 470 nm, T is at least approximately 51.5 percent of Tₘₐₓ and at most approximately 77.6 percent of Tₘₐₓ; for wavelengths between approximately 470 and 475 nm, T is at least approximately 36.6 percent of Tₘₐₓ and at most approximately 65.2 percent of Tₘₐₓ; for wavelengths between approximately 475 and 480 nm, T is at least approximately 24.1 percent of Tₘₐₓ and at most approximately 52.4 percent of Tₘₐₓ; for wavelengths between approximately 480 and 485 nm, T is at least approximately 15.1 percent of Tₘₐₓ and at most approximately 40.04 percent of Tₘₐₓ; for wavelengths between approximately 485 and 490 nm, T is at least approximately 8.9 percent of Tₘₐₓ and at most approximately 29.7 percent of Tₘₐₓ; for wavelengths between approximately 490 and 495 nm, T is at least approximately 4.7 percent of Tₘₐₓ and at most approximately 21.1 percent of Tₘₐₓ; and for wavelengths between approximately 495 and 500 nm, T is at most approximately 14.0 percent of Tₘₐₓ.

Various embodiments of tristimulus calorimeters on a single semiconductor chip having at least three detectors, each detector being coated by colorant filters, and at least one filter having a transmission spectrum that descends from a maximum value (between approximately 445 and 450 nm) to fifteen percent of the maximum value (between approximately 485 and 495 nm), have been described. Colorimeters determine CIE tristimulus values of an incident light from inputs to the filters and detectors. Colorimeters having integral dye filters may be constructed on a single silicon chip embodying all of the detectors and electronics, coated over each detector by a permanently deposited filter layer. Colorants may be directly deposited on the detectors, rather than using a plastic substrate for a filter.

Relative to previous multiple-channel calorimeters, such as those taught by U.S. Pat. No. 6,163,377, which is herein incorporated by reference in its entirety, the present invention has many advantages, including greater optical efficiency, increased lifetime, increased mechanical robustness, reduced cost of manufacture, and reduced cost of calibration. Greater optical efficiency is achieved, because the detectors can be abutted and need not be separated. This proximity reduces the requirements for diffusers and lenses that have in the past been required to homogenize the light over the large area of the composite sensor. Removing optical elements increases light throughput and efficiency for a given active area of the device. Because no glue or mechanical attachment is necessary, the lifetime of the device is increased. Furthermore, constructing integral dye filters by using the purple colorant (that has been specifically formulated to have a transmission coefficient that as a function of wavelength descends from a maximum value between approximately 445 and 450 nm to fifteen percent of the maximum value between 485 and 495 nm), in combination with standard red, green, and yellow colorants, increases the closeness of the color-matching functions of the spectral sensitivities of a calorimeter, increasing its accuracy. Reduced cost of calibration is achieved, because unit-to-unit uniformity is increased so that calibration of each unit may be unnecessary. Instead, a few representative units in a lot can be calibrated. In addition, the small size of the colorimeter chip and its associated components allows the complete colorimeter to be embedded in the light emitting source that is to be measured, as shown in FIGS. 9B and 10B (and could also be embedded in the embodiment illustrated in FIG. 11A).

Various applications, including a computer monitor calibration system, a home theatre display calibration system, a projector calibration system, an ambient light measurement system, and a light emitting diode (LED) measurement and control application have also been described. For a computer monitor and related applications, the sensor can be either free-standing or embedded in the monitor being calibrated. For example, a colorimeter having integral dye filters according to the present invention may be implemented in a device such as the Spyder3™ calorimeter, available from Datacolor of Lawrenceville, N.J., which is a colorimeter that allows advanced amateurs, professionals, and consumers to calibrate monitors and to create International Color Consortium (ICC) or other industry-standard display profiles for cathode ray tube (CRT), LCD, notebook, and/or projective displays. One of skill in the art will recognize that the present invention may be implemented in many other colorimetry applications in many industries.

While the foregoing is directed to embodiments of the present invention, other and further embodiments of the invention may be devised without departing from the basic scope thereof, and the scope thereof is determined by the claims that follow.

What is claimed is:

1. A solid-state color-measuring device, comprising:
a plurality of photodetectors; and
a plurality of filters permanently deposited on the plurality of photodetectors, wherein at least one of the plurality of filters comprises a single colorant layer having a transmission coefficient as a function of wavelength that descends from a maximum value between approximately 445 and 450 nm to fifteen percent of the maximum value between approximately 485 and 495 nm.

2. The solid-state color measuring device of claim 1, further comprising:
a plurality of channels including the plurality of photodetectors and the plurality of filters so that linear combinations of a plurality of spectral responses of the plurality of channels approximate a set of Commission Internationale de I'Eclairage (CIE)-like target color-matching functions.

3. The solid-state color-measuring device of claim 2, wherein each of the plurality of filters comprises a colorant layer, each colorant layer having a thickness such that thicknesses of the colorant layers in combination produce an output having the plurality of spectral responses.

4. The solid-state color-measuring device of claim 3, wherein each colorant layer is permanently deposited onto a single photodetector.

5. The solid-state color-measuring device of claim 3, wherein each colorant layer is permanently deposited onto at least two photodetectors.

6. The solid-state color-measuring device of claim 3, wherein a set of combinations of colorant layers is determined, each of the combinations being determined so that the output has the plurality of spectral responses, and further wherein one of the combinations is selected from the set having a best solution and meeting predetermined performance criteria, the one of the combinations being permanently deposited onto the solid-state color-measuring device.

7. The solid-state color measuring device of claim 1, wherein the plurality of photodetectors comprises four photodetectors, and the plurality of filters comprises four filters.

8. The solid-state color measuring device of claim 1, wherein the plurality of photodetectors comprises five photodetectors, and the plurality of filters comprises five filters.

9. The solid-state color measuring device of claim 8, wherein at least one of the plurality of filters comprises a single clear layer.

10. The solid-state color measuring device of claim 1, wherein a relative transmission function for the at least one of the plurality of filters comprises a curve that lies between a lower bound and an upper bound.

11. The solid-state color measuring device of claim 10, wherein the lower bound is between approximately 410 nm and approximately 495 nm.

12. The solid-state color measuring device of claim 10, wherein the upper bound is between approximately 460 nm and approximately 500 nm.

13. The solid-state color measuring device of claim 10, wherein the curve transitions from high transmittance to low transmittance between approximately 450 nm and approximately 500 nm.

14. The solid-state color measuring device of claim 1, wherein a transmittance of the at least one of the plurality of filters is low relative to transmittances of a remainder of the plurality of filters.

15. The solid-state color-measuring device of claim 1, wherein the plurality of photodetectors is identical prior to attachment of the plurality of filters.

16. The solid state color-measuring device of claim 1, wherein the at least one of the plurality of filters is associated with a transmission coefficient (T) as a function of wavelength that satisfies a set of conditions relative to a maximum transmission (Tₘₐₓ) of T, the set of conditions comprising:
for wavelengths between approximately 410 and 415 nm, T is at least approximately 32.2 percent of Tₘₐₓ;
for wavelengths between approximately 415 and 420 nm, T is at least approximately 40.0 percent of Tₘₐₓ;
for wavelengths between approximately 420 and 425 nm, T is at least approximately 50.42 percent of Tₘₐₓ;
for wavelengths between approximately 425 and 430 nm, T is at least approximately 60.4 percent of Tₘₐₓ;
for wavelengths between approximately 430 and 435 nm, T is at least approximately 71.9 percent of Tₘₐₓ;
for wavelengths between approximately 435 and 440 nm, T is at least approximately 84.8 percent of Tₘₐₓ;
for wavelengths between approximately 440 and 445 nm, T is at least approximately 94.7 percent of Tₘₐₓ;
for wavelengths between approximately 445 and 450 nm, T is at least approximately 98.0 percent of Tₘₐₓ and at most approximately Tₘₐₓ;
for wavelengths between approximately 450 and 455 nm, T is at least approximately 93.0 percent of Tₘₐₓ and at most approximately Tₘₐₓ;
for wavelengths between approximately 455 and 460 nm, T is at least approximately 81.7 percent of Tₘₐₓ and at most approximately 95.4 percent of Tₘₐₓ;
for wavelengths between approximately 460 and 465 nm, T is at least approximately 67.4 percent of Tₘₐₓ and at most approximately 87.8 percent of Tₘₐₓ;
for wavelengths between approximately 465 and 470 nm, T is at least approximately 51.5 percent of Tₘₐₓ and at most approximately 77.6 percent of Tₘₐₓ;
for wavelengths between approximately 470 and 475 nm, T is at least approximately 36.6 percent of Tₘₐₓ and at most approximately 65.2 percent of Tₘₐₓ;
for wavelengths between approximately 475 and 480 nm, T is at least approximately 24.1 percent of Tₘₐₓ and at most approximately 52.4 percent of Tₘₐₓ;
for wavelengths between approximately 480 and 485 nm, T is at least approximately 15.1 percent of Tₘₐₓ and at most approximately 40.04 percent of Tₘₐₓ;
for wavelengths between approximately 485 and 490 nm, T is at least approximately 8.9 percent of Tₘₐₓ and at most approximately 29.7 percent of Tₘₐₓ;
for wavelengths between approximately 490 and 495 nm, T is at least approximately 4.7 percent of Tₘₐₓ and at most approximately 21.1 percent of Tₘₐₓ; and
for wavelengths between approximately 495 and 500 nm, T is at most approximately 14.0 percent of Tₘₐₓ.

17. A colorimeter, comprising:
a semiconductor substrate having at least four photodetectors;
at least four filters permanently deposited on the at least four photodetectors, where at least one of the at least four filters comprises a single colorant layer having a transmission coefficient as a function of wavelength that descends from a maximum value between approximately 445 and 450 nm to fifteen percent of the maximum value between approximately 485 and 495 nm; and
at least four channels including the at least four photodetectors and the at least four filters, so that linear combinations of a plurality of spectral responses of the at least four channels approximate a set of Commission Internationale de I'Eclairage (CIE)-like target color-matching functions.

18. The calorimeter of claim 17, wherein the at least four filters are integral with the at least four photodetectors.

19. The colorimeter of claim 17, wherein the semiconductor substrate has five photodetectors.

20. The calorimeter of claim 19, wherein one of the at least five filters comprises a single clear layer.

21. The calorimeter of claim 17, wherein a relative transmission function for the at least one of the at least four filters comprises a curve that lies between a lower bound and an upper bound.
